(19) United States
(12) Patent Application Publication
(10) Pub. No.: US 2010/0017530 A1
(43) Pub. Date: Jan. 21, 2010

(54) Priority-Based Physical Layer Transmission Rate Control For Video Streaming Over Wireless Networks

(75) Inventor: Sudhanshu Gaur, Campbell, CA (US)

Correspondence Address: MATTINGLY & MALUR, P.C., 1800 DIAGONAL ROAD, SUITE 370, ALEXANDRIA, VA, 22314, US

(73) Assignee: Hitachi, Ltd., Tokyo (JP)

(21) Appl. No.: 12/144,534

(22) Filed: Jun. 23, 2008

(51) Int. Cl. G06F 15/16

(52) U.S. Cl. 709/231; 375/E07.021

(57) ABSTRACT

Priority-based physical layer transmission rate control for video streaming over wireless networks comprises receiving a video packet comprising at least part of a video frame. The video frame includes multiple slices, and each of the slices includes multiple macroblocks of a particular type. A current physical layer transmission bit rate is determined based at least in part on (1) a relative importance of the packet with respect to its impact on video quality and (2) a number of retransmissions of the packet at a previous physical layer transmission bit rate. The packet is transmitted at the current physical layer transmission bit rate.

### FIELD OF THE INVENTION

The present invention relates to the field of computer science. More particularly, the present invention relates to priority-based physical layer transmission rate control for video streaming over wireless networks.

### BACKGROUND OF THE INVENTION

In applications that stream packets containing video data over wireless networks, packet loss due to the varying nature of the wireless medium can adversely affect the viewer experience. To reduce the number of lost packets due to transmission errors, wireless networks typically deploy a retransmission mechanism wherein a packet is retransmitted if the original transmission fails. However, such solutions typically make a limited number of retransmission attempts, which often results in packet losses.

Rate adaptation algorithms such as Onoe and SampleRate aim to maximize application throughput over a wireless medium having a time-varying transfer function. The relative performance of these algorithms depends on the exact nature of the wireless medium. However, such algorithms do not adapt to the requirements of time-sensitive applications such as video streaming.

Another solution adjusts the packet transmission rate according to a signal-to-noise ratio (SNR) estimate at the receiver. Packets with corrupted payloads are allowed to reach the receiver application, adversely affecting the quality of the viewer experience. The decision to allow corrupted packets to reach application layer is made in accordance with loss toleration levels, which depend on the relative importance of specific video packets.

Accordingly, a need exists in the art for an improved solution for video streaming.

### SUMMARY OF THE INVENTION

Priority-based physical layer transmission rate control for video streaming over wireless networks comprises receiving a video packet comprising at least part of a video frame. The video frame includes multiple slices, and each of the slices includes multiple macroblocks of a particular type. A current physical layer transmission bit rate is determined based at least in part on (1) a relative importance of the packet with respect to its impact on video quality and (2) a number of retransmissions of the packet at a previous physical layer transmission bit rate. The packet is transmitted at the current physical layer transmission bit rate.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram that illustrates a system for priority-based physical layer transmission rate control for video streaming over wireless networks in accordance with one embodiment of the present invention.

FIG. 2 is a block diagram that illustrates a system for priority-based physical layer transmission rate control for video streaming over wireless networks in accordance with one embodiment of the present invention.

FIG. 3 is a block diagram that illustrates a transmitter for priority-based physical layer transmission rate control for video streaming over wireless networks in accordance with one embodiment of the present invention.

FIG. 4A is a block diagram that illustrates a typical GOP structure of a compressed video sequence.

FIG. 4B is a block diagram that illustrates an application layer MPEG packet and a MAC layer MPEG packet.

FIG. 4C is a block diagram that illustrates an MPEG packet header.

FIG. 5A is a flow diagram that illustrates a high-level method for priority-based physical layer transmission rate control for video streaming over wireless networks from the perspective of a transmitter, in accordance with one embodiment of the present invention.

FIG. 5B is a flow diagram that illustrates a method for associating a physical layer transmission bit rate with packet type, in accordance with one embodiment of the present invention.

FIG. 6A is a block diagram that illustrates classifying the importance of packets according to their impact on video quality, in accordance with one embodiment of the present invention.

FIG. 6B is a block diagram that illustrates classifying the importance of packets according to their impact on video quality, in accordance with one embodiment of the present invention.

FIG. 7 is a flow diagram that illustrates a low-level method for priority-based physical layer transmission rate control for video streaming over wireless networks from the perspective of a transmitter, in accordance with one embodiment of the present invention.

FIG. 8A is a block diagram that illustrates an example bit rate selection for successive retransmissions of packets depending on the relative importance of the packets being transmitted in accordance with one embodiment of the present invention.

FIG. 8B is a block diagram that illustrates an example retransmission rate adaptation scheme for medium-importance packets in accordance with one embodiment of the present invention.

### DETAILED DESCRIPTION

Embodiments of the present invention are described herein in the context of priority-based physical layer transmission rate control for video streaming over wireless networks. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

Example embodiments of the present invention improve the video streaming experience over wireless network by adapting the physical layer retransmission bit rate in the event of consecutive packet losses based on the importance of video packets. Retransmission bit rates are adapted to minimize the probability of losing important video packets. Successive retransmission bit-rates are adapted according to the importance of the packet with respect to its impact on video quality, as well as the prevailing channel condition. The packets of the highest importance are guaranteed the highest probability of successful transmission, whereas the packets having the lowest importance may not be guaranteed the same probability of successful transmission. If a packet suffers from transmission errors, the subsequent retransmission attempts are made at bit-rates which are lower than or equal to the previous transmission rate, depending on the relative importance of the packet.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, California, Windows Vista™, Windows NT® Windows XP, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “network” includes local area networks (LANs), wide area networks (WANs), metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

In the context of the present invention, the term “network interface” describes the means by which users access a network for the purposes of communicating across it or retrieving information from it.

In the context of the present invention, the term “user interface” describes any device or group of devices for presenting and/or receiving information and/or directions to and/or from persons. A user interface may comprise a means to present information to persons, such as a visual display projector or screen, a loudspeaker, a light or system of lights, a printer, a Braille device, a vibrating device, or the like. A user interface may also include a means to receive information or directions from persons, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

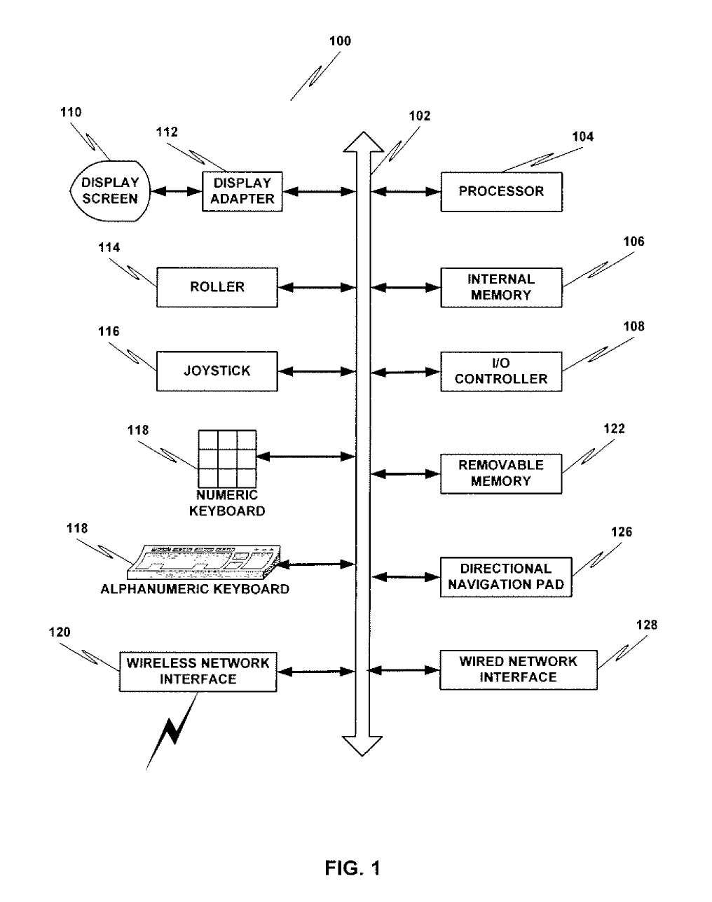

FIG. 1 depicts a block diagram of a computer system 100 suitable for implementing aspects of the present invention. As shown in FIG. 1, system 100 includes a bus 102 which interconnects major subsystems such as a processor 104, an internal memory 106 (such as a RAM), an input/output (I/O) controller 108, a removable memory (such as a memory card) 122, an external device such as a display screen 110 via display adapter 112, a roller-type input device 114, a joystick 116, a numeric keyboard 118, an alphanumeric keyboard 118, directional navigation pad 126 and a wireless interface 120. Many other devices can be connected. Wireless network interface 120, wired network interface 128, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 1 to be present to practice the present invention. Furthermore, the devices and subsystems may be interconnected in different ways from that shown in FIG. 1. Code to implement the present invention may be operably disposed in internal memory 106 or stored on storage media such as removable memory 122, a floppy disk, a thumb drive, a CompactFlash® storage device, a DVD-R (“Digital Versatile Disc” or “Digital Video Disc” recordable), a DVD-ROM (“Digital Versatile Disc” or “Digital Video Disc” read-only memory), a CD-R (Compact Disc-Recordable), or a CD-ROM (Compact Disc read-only memory).

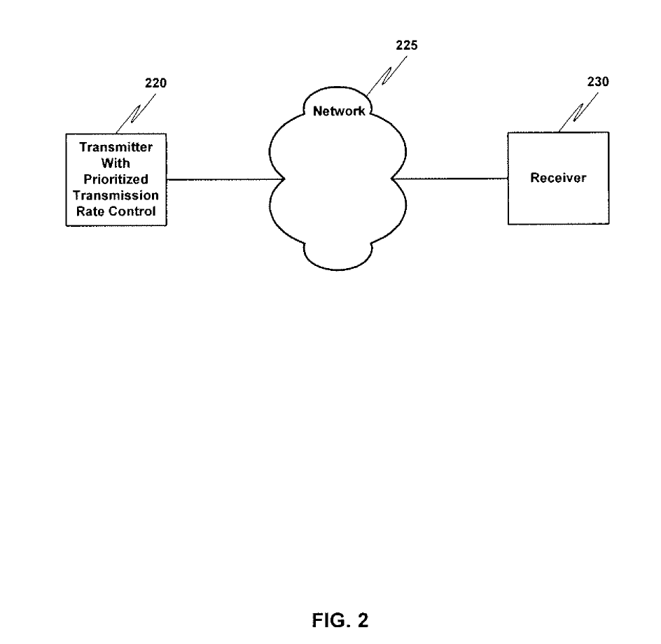

FIG. 2 is a block diagram that illustrates a system for priority-based physical layer transmission rate control for video streaming over wireless networks in accordance with one embodiment of the present invention. As shown in FIG. 2, transmitter 220 is communicatively coupled to receiver 230 via network 225. According to one embodiment of the present invention, transmitter 220 is configured to receive a video packet comprising at least part of a video frame, where the video frame comprises a plurality of slices, with each of the slices comprising a plurality of macroblocks of a particular type. Transmitter 220 is further configured to determine a current physical layer transmission bit rate based at least in part on (1) a relative importance of the packet with respect to its impact on video quality and (2) a number of retransmissions of the packet at a previous physical layer transmission bit rate. Transmitter 220 is further configured to transmit the packet to one or more receivers 230 at the current physical layer transmission bit rate.

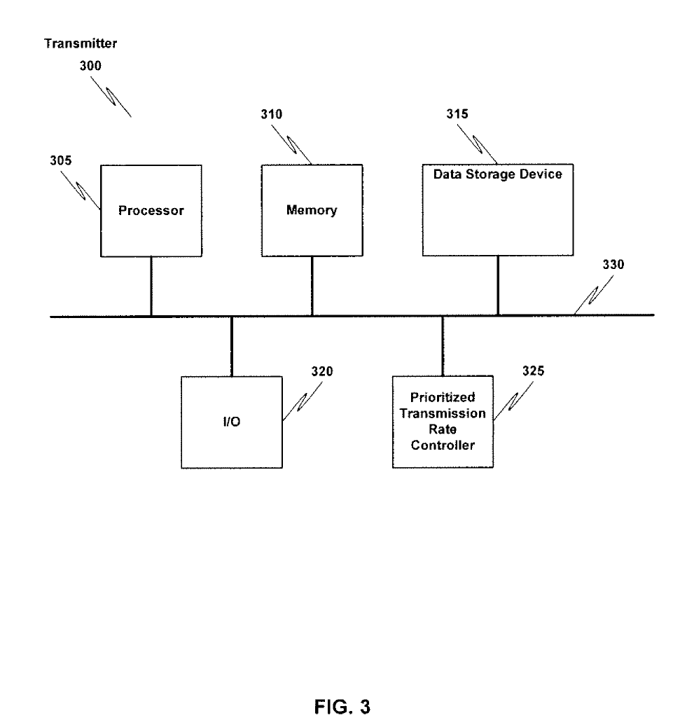

FIG. 3 is a block diagram that illustrates a transmitter for priority-based physical layer transmission rate control for video streaming over wireless networks in accordance with one embodiment of the present invention. FIG. 3 provides more detail for reference numeral 220 of FIG. 2. As shown in FIG. 3, transmitter 300 comprises a processor 305, memory 310, data storage device 315, input/output (I/O) interface 320, and prioritized transmission rate controller 325 coupled via bus 330. Processor 305 may be configured to perform prioritized transmission rate control of packets as disclosed herein, Alternatively, prioritized transmission rate controller 325 may be configured to perform prioritized transmission rate control under control of processor 305. Memory 310 and data storage device 315 may be used for storing or buffering packets before they are transmitted to one or more receivers. I/O interface 320 is configured to provide an interface between transmitter 300 and other devices.

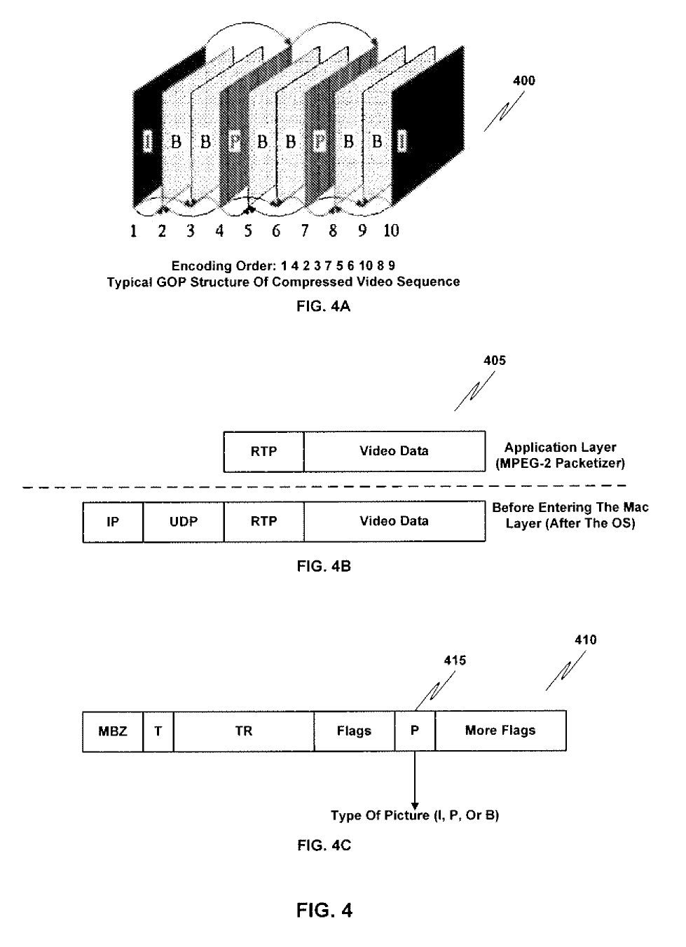

FIG. 4A is a block diagram that illustrates a typical GOP structure of a compressed video sequence. MPEG encoding exploits intra-frame spatial redundancy and inter-frame temporal redundancy. Intra-frame encoding is accomplished using DCT based compression for the reduction of spatial redundancy, while block-based motion compensation is used for exploiting temporal redundancy for inter-frame encoding. A MPEG stream comprises three kinds of frames, I-frames (intra-frame), P-frames (forward predicted frames) and B frames (bi-directional predicted frames).

I-frames can be reconstructed without the reference of any other frames. P-frames are forward predicted from the last I-frames or P-frames. B-frames are forward predicted and backward predicted from the last and next I-frames or P-frames. A number of these frames are grouped to form a Group Of Picture (GOP). A GOP has little or no dependence on the pictures in adjacent GOPs. FIG. 4A illustrates a typical GOP, indicating the forward prediction of the P-frames, the forward prediction of the B-frames, and the backward prediction of B-frames.

Each of these frames comprises a series of independently decodable units called slices. The slices can be further fragmented to a series of macroblocks. The macroblocks depend on neighboring macroblocks within each slice for predictive coding of transform coefficient and motion vectors. However, macroblocks in different slices are not dependent on each other. I-frames can only contain I-macroblocks. However, P-frames and B-frames can also contain I-macroblocks.

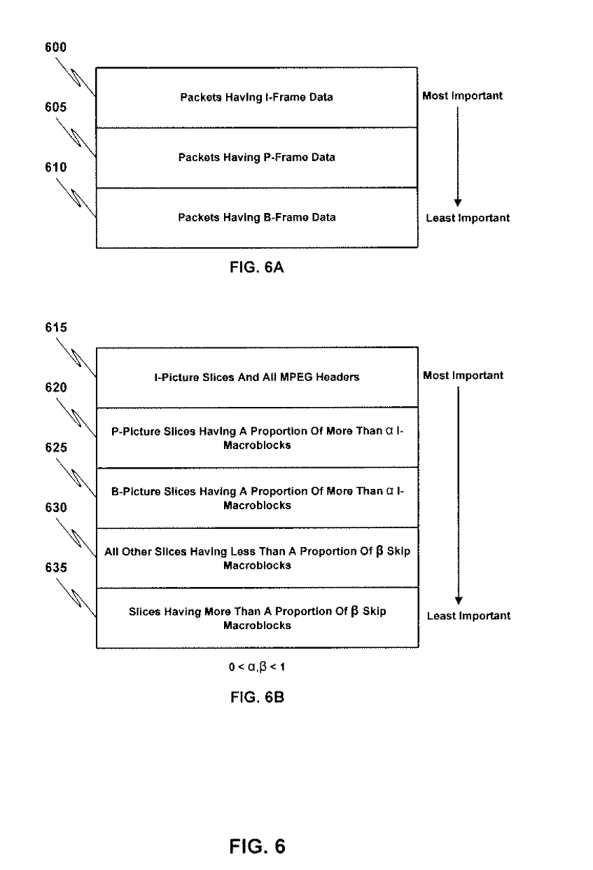

FIG. 4B is a block diagram that illustrates an application layer MPEG packet and a MAC layer MPEG packet. And FIG. 4C is a block diagram that illustrates an MPEG packet header. According to one embodiment of the present invention, the importance of transmitting a slice with respect to its impact on video quality is indicated by the type-of-picture flag 415 of the packet header 410 for the packet containing all or part of the slice. Use of the type-of-picture flag 415 in determining the importance of video data is discussed in detail below with respect to FIGS. 6A and 6B.

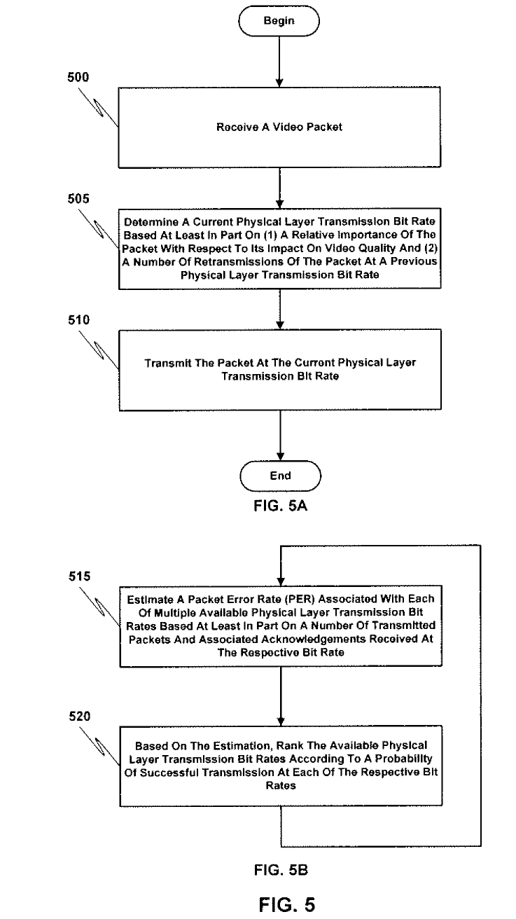

FIG. 5A is a flow diagram that illustrates a high-level method for priority-based physical layer transmission rate control for video streaming over wireless networks from the perspective of a transmitter, in accordance with one embodiment of the present invention. The processes illustrated in FIG. 5A may be implemented in hardware, software, firmware, or a combination thereof. For example, the processes illustrated in FIG. 5A may be performed by transmitter 220 of FIG. 2. At 500, a video packet comprising at least part of a video frame is received. The video frame comprises multiple slices, with each of the slices having multiple macroblocks of a particular type. At 505, a current physical layer transmission bit rate is determined based at least in part on (1) a relative importance of the packet with respect to its impact on video quality and (2) a number of retransmissions of the packet at a previous physical layer transmission bit rate. At 510, the packet is transmitted at the current physical layer transmission bit rate determined at 505.

According to example embodiments of the present invention, the packet error rates (PERs) for each available transmission rate is determined, and this information is used in determining which transmission rate to use for packets of a particular type. Consider a set R of available physical layer transmission rates, R_{N}>R_{N-1}> . . . >R₁. Let the PER associated with rate Rₙ be Eₙ. According to example embodiments of the present invention, a transmitter is configured to estimate PER for all available rates based on the statistics of number of transmitted packets and acknowledgements received. A transmitter may also be configured to use a signal-to-noise ratio (SNR) value and other channel statistics to compute theoretical values for PER. In general, E_{N}>E_{N-1}> . . . >E₁, but in practice it is possible for this relationship not to hold due to different transmissions techniques used to achieve a particular rate. For example in IEEE 802.11g, a 1-Mbps rate is achieved using DSSS, whereas 6-Mbps rate is achieved using OFDM. In some situations it is possible for 1-Mbps bit-rate to have a higher PER compared to a 6-Mbps bit-rate, and vice versa. Associating a physical layer transmission bit rate with a packet type is explained in more detail below, with reference to FIG. 5B.

FIG. 5B is a flow diagram that illustrates a method for associating a physical layer transmission bit rate with a packet type, in accordance with one embodiment of the present invention. The processes illustrated in FIG. 5B may be implemented in hardware, software, firmware, or a combination thereof. For example, the processes illustrated in FIG. 5B may be performed by transmitter 220 of FIG. 2. At 515, a packet error rate (PER) associated with each of multiple available physical layer transmission bit rates is estimated based at least in part on (1) a number of transmitted packets and (2) associated acknowledgements received at the respective physical layer transmission bit rate. At 520, the multiple available physical layer transmission bit rates are ranked according to a probability of successful transmission at each of the respective physical layer transmission bit rates. The ranking is based at least in part on the estimating.

According to one embodiment of the present invention, the estimating and ranking of FIG. 5B are performed prior to the determination step discussed with respect to reference numeral 505 of FIG. 5A. According to another embodiment of the present invention, the estimating and ranking performed periodically.

According to one embodiment of the present invention, the transmitted packets used for the estimating comprise probe packets. According to another embodiment of the present invention, the transmitted packets used for the estimating comprise packets of a compressed video sequence.

FIG. 6A is a block diagram that illustrates classifying the importance of packets according to their impact on video quality, in accordance with one embodiment of the present invention. As shown in FIG. 6A, according to one embodiment of the present invention, the relative importance of packets comprising I-frame data 600, P-frame data 605, and B-frame 610 data is high, medium, and low, respectively.

FIG. 6B is a block diagram that illustrates classifying the importance of packets according to their impact on video quality, in accordance with one embodiment of the present invention. As shown in FIG. 6B, according to another embodiment of the present invention, the relative importance of packets, in decreasing order of importance, is:
1. packets comprising one or more I-picture slices or MPEG headers (615);
2. packets comprising one or more P-picture slices comprising a proportion of more than αI-macroblocks (620);
3. packets comprising one or more B-picture slices comprising a proportion of more than αI-macroblocks (625);
4. packets comprising one or more slices comprising less than a proportion of β Skip macroblocks (630); and
5. packets comprising one or more slices comprising more than a proportion of β Skip macroblocks (635),
   where 0<α, β<1.

According to one embodiment of the present invention, values for α and β are obtained by analyzing decoded video transmitted using different values of α and different values of β. The values of α and β(0<α, β<1) can be chosen based on the typical characteristics of the video content. While it is difficult to determine the values of α and β analytically, they can be obtained empirically by analyzing the decoded video quality after lossy transmission under varying values of each parameter. The macroblock type information for a slice cannot be directly obtained from MPEG-encoded packets. Therefore, in the case of P- and B-pictures, the slice data needs to be examined in order to determine the macroblock types contained in the slice. According to one embodiment of the present invention, a cross-layer approach, in which the macroblock type information is provided by the application layer as metadata (e.g., as a 3-bit class identifier), is used to determine the macroblock types contained in a slice. In addition to the macroblock type information, each slice includes a sequence number to allow the decoder to determine the position of the slice in the decoder buffer. This can be achieved by packetizing each slice into one RTP packet and supplying an RTP sequence number for each packet.

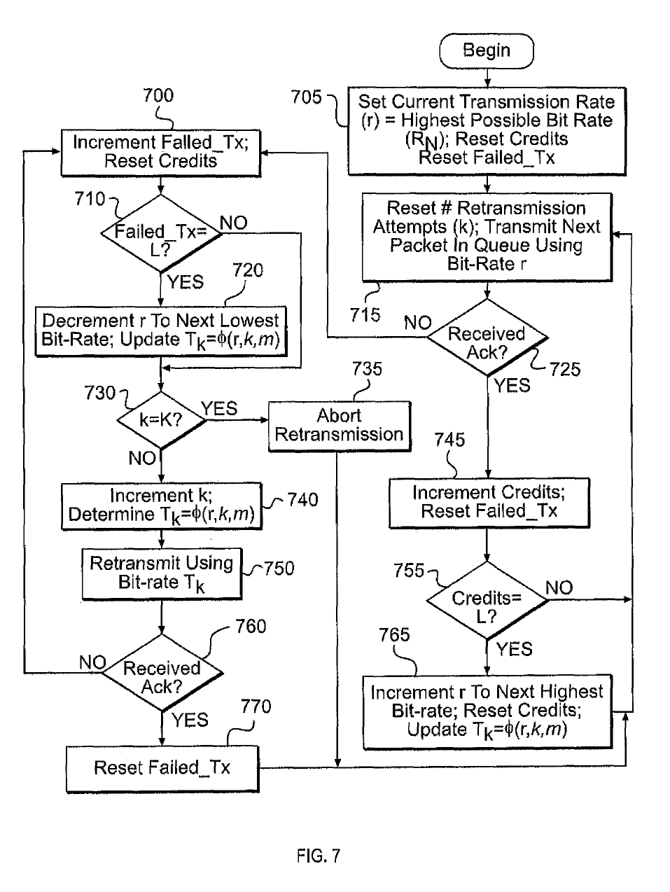

FIG. 7 is a flow diagram that illustrates a low-level method for priority-based physical layer transmission rate control for video streaming over wireless networks from the perspective of a transmitter, in accordance with one embodiment of the present invention. The processes illustrated in FIG. 7 may be implemented in hardware, software, firmware, or a combination thereof. For example, the processes illustrated in FIG. 7 may be performed by transmitter 220 of FIG. 2. According to this embodiment, a retransmission rate Tₖ is expressed as Tₖ=Φ(r, k, m), where r indicates the current transmission bit-rate, k denotes the retransmission attempt number, and m indicates the priority level of the packet. At 705, a current transmission rate (r) is set to a highest possible bit rate (R_{N}), a value indicating a number of successful consecutive transmissions (“credits”) is reset, and a value indicating a number of consecutive failed transmissions (“Failed_Tx”) is reset. At 715, a number of retransmission attempts (k) is reset, and a next packet in a queue or buffer is transmitted using the current transmission bit rate (r). At 725, a determination is made regarding whether an acknowledgement for the transmitted packet was received.

If the determination at 725 indicates an acknowledgement was received, at 745 the value indicating the number of consecutive successful transmissions (“credits”) is incremented, and the value indicating the number of consecutive failed transmissions (“Failed_Tx”) is reset. At 755, a determination is made regarding whether the value indicating the number of consecutive successful transmissions (“credits”) is greater than a number (“L”) of consecutive successful transmissions required to increment the current bit rate (r). If the value indicating the number (“L”) of consecutive successful transmissions is greater than a number of consecutive successful transmissions required to increment the current bit rate (r), at 765 the current bit rate (r) is incremented to the next-highest bit rate, and transmission of another packet at this new bit rate begins at 715. If at 755 the value indicating the number of consecutive successful transmissions (“credits”) is not greater than the number (“L”) of consecutive successful transmissions required to increment the current bit rate (r), transmission of another packet at the same transmission rate begins at 715.

If at 725 it is determined that an acknowledgement of the transmitted packet was not received, the value indicating the number of consecutive successful transmissions (“credits”) is reset and the value indicating the number of consecutive failed transmissions (“Failed_Tx”) is incremented at 700. At 710, a determination is made regarding whether the value indicating the number of consecutive failed transmissions (“Failed_Tx”) matches the value indicating the number (“L”) of consecutive failed transmissions required to change the current transmission rate to the next-lowest transmission rate. If the value indicating the number of consecutive failed transmissions (“Failed_Tx”) matches the value indicating the number (“L”) of consecutive failed transmissions required to change the current transmission rate to the next-lowest transmission rate, the current transmission rate (“r”) is set to the next-lowest transmission rate at 720. At 730, a determination is made regarding whether a value indicating a number of packet retransmissions (“k”) matches a value indicating a number of packet retransmissions required before aborting retransmission attempts (“K”). If the value indicating the number of packet retransmissions (“k”) matches the value indicating the number of packet retransmissions required before aborting retransmission attempts (“K”), retransmission of the packet is aborted at 735, and transmission of the next packet at the current transmission rate (“r”) begins at 715.

If at 730 the value indicating the number of packet retransmissions (“k”) does not match the value indicating the number of packet retransmissions required before aborting retransmission attempts (“K”), at 740 the value indicating the number of packet retransmissions (“k”) is incremented, and a new transmission rate is determined based at least in part on the current transmission rate (“r”), the number of retransmissions of the packet at that rate (“k”), and the importance of the video data in the packet (“m”). At 750, the packet is retransmitted using the transmission bit rate (Tₖ) determined at 740.

At 760, a determination is made regarding whether an acknowledgement (“ack”) of the retransmitted packet was received. If an acknowledgement of the retransmitted packet was not received, the decision to retransmit again at the same rate, retransmit at a different rate, or abort retransmission of the packet, begins at 700. If at 760 it is determined that an acknowledgement of the retransmitted packet was received, the value indicating the number of consecutive failed transmissions (“Failed_Tx”) is reset at 770, and transmission of the next packet at the current transmission rate (“r”) begins at 705.

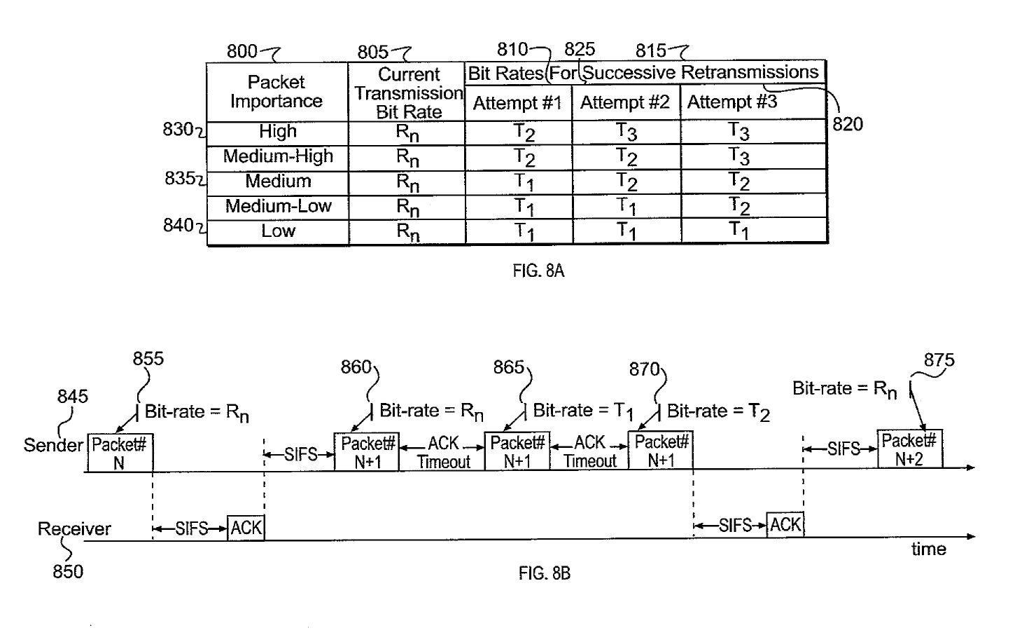

FIG. 8A is a block diagram that illustrates an example bit rate selection for successive retransmissions of packets depending on the relative importance of the packets being transmitted in accordance with one embodiment of the present invention. In the example shown in FIG. 8A, Rₙ≧T₁, T₂, T₃. For example, consider an IEEE 802.11g based wireless network with maximum retransmissions for all packet importance levels set to 3. If the current transmission bit-rate is Rₙ=48 Mbps, then depending upon the PER statistics of different rates, one may choose T₁=Rₙ=48 Mbps, T₂=Rₙ₋₁=36 Mbps and T₃=Rₙ₋₃=18 Mbps, assuming Eₙ≧Eₙ₋₁≧Eₙ₋₃. The retransmission rates can be adapted following the continuously changing PER statistics of the different bit-rates. FIG. 8B shows an example retransmission rate adaptation for “medium” importance packets in IEEE 802.11a network, in accordance with one embodiment of the present invention.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method comprising:
receiving a video packet comprising at least part of a video frame, the video frame comprising a plurality of slices, each of the slices comprising a plurality of macroblocks of a particular type;
determining a current physical layer transmission bit rate based at least in part on a relative importance of the packet with respect to its impact on video quality and a number of retransmissions of the packet at a previous physical layer transmission bit rate; and
transmitting the packet at the current physical layer transmission bit rate.

2. The method of claim 1 wherein the relative importance of packets comprising I-frame data, P-frame data, and B-frame data is high, medium, and low, respectively.

3. The method of claim 1 wherein the relative importance of packets, in decreasing order of importance, is:
packets comprising one or more I-picture slices or MPEG headers;
packets comprising one or more P-picture slices comprising a proportion of more than αI-macroblocks;
packets comprising one or more B-picture slices comprising a proportion of more than αI-macroblocks,
packets comprising one or more slices comprising less than a proportion of β Skip macroblocks; and
packets comprising one or more slices comprising more than a proportion of β Skip macroblocks, wherein (0<α, β<1).

4. The method of claim 3 wherein values for α and β are obtained by analyzing decoded video transmitted using different values of α and different values of β.

5. The method of claim 1 further comprising:
prior to the determining, estimating a packet error rate (PER) associated with each of a plurality of available physical layer transmission bit rates based at least in part on a number of transmitted packets and associated acknowledgements received at the respective physical layer transmission bit rate; and
ranking the plurality of available physical layer transmission bit rates according to a probability of successful transmission at each of the respective physical layer transmission bit rates, the ranking based at least in part on the estimating.

6. The method of claim 5 wherein the transmitted packets used for the estimating comprise probe packets.

7. The method of claim 5 wherein the transmitted packets used for the estimating comprise packets of a compressed video sequence.

8. The method of claim 5 wherein the estimating is performed periodically.

9. The method of claim 5 wherein
the PER of a first bit rate of the plurality of available physical layer transmission bit rates is higher than the PER of a second bit rate of the plurality of available physical layer transmission bit rates; and
the first bit rate is higher than the second bit rate.

10. The method of claim 5 wherein
the PER of a first bit rate of the plurality of available physical layer transmission bit rates is higher than the PER of a second bit rate of the plurality of available physical layer transmission bit rates; and
the first bit rate is lower than the second bit rate.

11. An apparatus comprising:
a memory; and
a processor configured to:
receive a video packet comprising at least part of a video frame, the video frame comprising a plurality of slices, each of the slices comprising a plurality of macroblocks of a particular type;
determine a current physical layer transmission bit rate based at least in part on a relative importance of the packet with respect to its impact on video quality and a number of retransmissions of the packet at a previous physical layer transmission bit rate; and
transmit the packet at the current physical layer transmission bit rate.

12. The apparatus of claim 11 wherein the relative importance of packets comprising I-frame data, P-frame data, and B-frame data is high, medium, and low, respectively.

13. The apparatus of claim 11 wherein the relative importance of packets, in decreasing order of importance, is:
packets comprising one or more I-picture slices or MPEG headers;
packets comprising one or more P-picture slices comprising a proportion of more than αI-macroblocks;
packets comprising one or more B-picture slices comprising a proportion of more than αI-macroblocks;
packets comprising one or more slices comprising less than a proportion of β Skip macroblocks; and
packets comprising one or more slices comprising more than a proportion of β Skip macroblocks, wherein (0<α, β<1).

14. The apparatus of claim 13 wherein the processor is further configured to obtain values for α and β by analyzing decoded video transmitted using different values of α and different values of β.

15. The apparatus of claim 11 wherein the processor is further configured to:
prior to the determining, estimate a packet error rate (PER) associated with each of a plurality of available physical layer transmission bit rates based at least in part on a number of transmitted packets and associated acknowledgements received at the respective physical layer transmission bit rate; and
rank the plurality of available physical layer transmission bit rates according to a probability of successful transmission at each of the respective physical layer transmission bit rates, the ranking based at least in part on the estimating.

16. The apparatus of claim 15 wherein the transmitted packets used for the estimating comprise probe packets.

17. The apparatus of claim 15 wherein the transmitted packets used for the estimating comprise packets of a compressed video sequence.

18. The apparatus of claim 15 wherein the processor is further configured to estimate the PER periodically.

19. The apparatus of claim 15 wherein
the PER of a first bit rate of the plurality of available physical layer transmission bit rates is higher than the PER of a second bit rate of the plurality of available physical layer transmission bit rates; and
the first bit rate is higher than the second bit rate.

20. The apparatus of claim 15 wherein
the PER of a first bit rate of the plurality of available physical layer transmission bit rates is higher than the PER of a second bit rate of the plurality of available physical layer transmission bit rates; and
the first bit rate is lower than the second bit rate.
